(19) United States
(12) Patent Application Publication
(10) Pub. No.: US 2006/0206909 A1
(43) Pub. Date: Sep. 14, 2006

(54) Thin brushless motor

(75) Inventors: Takashi Kuse, Minami-ku (JP); Itsuo Murata, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Minamiku (JP)

(21) Appl. No.: 11/372,378

(22) Filed: Mar. 10, 2006

(30) Foreign Application Priority Data
Mar. 11, 2005 (JP) 2005-070130

(51) Int. Cl. G11B 17/028

(52) U.S. Cl. 720/707

(57) ABSTRACT

A recording disk holedr hold the inner radius face of a recording disk by pressing the face only in the radial direction so that the top surface of a cover of a casing of a recording disk holding apparatus and the disk holding shoes are at the same or lower level of the top surface of a recording disk mounted on a mounting part. Grooves are formed in a contact surface of a nail portion. The grooves engage with the bumps and dips of the inner radius face of the recording disk, so that the frictional coefficient is improved and the recording disk holding force is improved.

### BACKGROUND OF THE INVENTION

1. Technical Field

The present invention relates to a thin brushless motor and, more particularly, a recording disk holding apparatus for holding a recording disk such as a CD or DVD.

2. Description of the Related Art

In recent years, the demand for reduction in thickness of a device for recording or reproducing information to/from a recording disk such as CD and DVD grows. Accordingly, the demand for reduction in thickness of a brushless motor for driving the recording disks also grows.

FIG. 9 shows a conventional brushless motor. Referring to FIG. 9, a recording disk holding apparatus 1 has a holding member 3 for holding a recording disk 2, a spring 4 supporting movement of the holding member 3 to the outside in the radial direction, and a casing 5 housing the holding member 3 and the spring 4.

In the conventional structure, however, the holding member 3 presses down the recording disk 2 from above, so that the holding member 3 has to be disposed above the recording disk 2 in the axial direction. Consequently, the casing 5 housing the holding member 3 also has to be formed so as to be tall in the axial direction. As a result, it prevents reduction in thickness of the device in which the brushless motor is housed. Further, since the holding member 3 presses down the recording disk 2 from above, the recording disk 2 is distorted by the holding force from above. As a result, there is the possibility that the recording disk 2 cannot be accurately recorded/reproduced.

FIG. 10 shows another conventional brushless motor. With reference to FIG. 10, a recording disk holding apparatus 6 holds the recording disk 2 by pressing down the recording disk 2 from above by a clamp member 7. However, since the clamp member 7 exists on the top face of the recording disk 2, the thickness of the recording disk holding apparatus 6 cannot be reduced.

### BRIEF SUMMARY OF THE INVENTION

The present invention is a recording disk holding apparatus for detachably holding a disk-shaped recording disk having a circular center opening, the apparatus being rotatable around a rotation axis. It comprises a casing, a mounting part formed, and a plurality of disk holding shoes accommodated in the casing. Each disk holding shoe has a nail portion on its tip and is projecting from the outer periphery of the casing. Each disk holding shoe also has a base portion accommodated in the casing and an elastic member which pushes the disk holding shoe outwardly to push the inner circumferential face of the recording disk. By pushing the inner circumferential face, the recording disk is held to the holding apparatus.

The grooves are formed on the outer end face of the disk holding shoes. The grooves slant off the rotational direction so that the recording disk is held firm when the recording disk is rotated.

The sectional profile of the groove is preferably asymmetrical so that the lower side of a groove is steep whereas the upper side of the groove is gentle compared to the horizontal plane. An disk holding apparatus with these feature can secure the recording disk more firmly.

Other features, elements, advantages and characteristics of the present invention will become more apparent from the following detailed description of the invention thereof with reference to the attached drawings.

### BRIEF DESCRIPTION OF THE SEVERAL VIEWS OF THE DRAWINGS

FIG. 1 is a schematic cross section showing an embodiment of a brushless motor according to the invention.

FIG. 2 is a top view showing the embodiment of the brushless motor according to the invention.

FIG. 3A is a top view of a casing in a disk holding apparatus according to the invention and FIG. 3B is a cross section taken along line Y-Y of FIG. 3A.

FIG. 4A is a top view of a holding member in the disk holding apparatus according to the invention, FIG. 4B is a cross section taken along line Z-Z of FIG. 4A, and FIG. 4C is a view seen from the direction of the arrow V of FIG. 4B.

FIG. 5 is a cross section taken along line X-X of FIG. 2 of a disk holding apparatus according to the invention.

FIG. 6A is an enlarged view of a U portion in FIG. 4B, and FIG. 6B is a front view of a contact face of a holding member according to the invention.

FIG. 7 is a diagram showing comparison between height of a disk holding apparatus of the present invention and height of a conventional disk holding apparatus.

FIG. 8 is a graph showing the relation between a third angle Φ3 increased by 10° with respect to the first angle Φ1 and the holding force in the axial direction.

FIG. 9 is a schematic cross section of a brushless motor according to the conventional technique.

FIG. 10 is a schematic cross section of another brushless motor according to the conventional technique.

### DETAILED DESCRIPTION OF THE INVENTION

General Configuration of Brushless Motor

FIG. 1 is a diagram showing an embodiment of a brushless motor of the present invention. The vertical direction of FIG. 1 is an axial direction. An alternate long and short dash line shows a rotation central axis of the motor. The rotation center axis matches the mounting direction of the recording disk 2.

With reference to FIG. 1, first, a fixed member 200 will be described.

The fixed member 200 is constructed by a sleeve 10, a housing 20, a stator 30, a plate 40, a washer 50, a mounting plate 60, and a circuit board 70 which will be described later.

The sleeve 10 is obtained by forming a sintered metal impregnated with oil into a cylindrical shape. The housing 20 formed by performing plasticity-process such as press process on copper alloy or the like is fixed by press-fitting on the outer surface of a cylindrical portion 11 of the sleeve 10. In the housing 20, an inner cylindrical part 21 for holding the sleeve 10 as a component of the fixed member, and an outer cylindrical part 22 disposed on the outside in the radial direction of the inner cylindrical part 21 are formed. On the lower side in the axial direction of the outer cylindrical part 22, a projection 23 projecting to the outside in the radial direction is formed. The stator 30 formed in an annular shape is fixed by adhesion so as to be in contact with each of the outer cylindrical part 22 and the projection 23.

Projections 24 and 25 are formed on the inside and outside in the radial direction of the lower end surface of the housing 20. The plate 40 is fixed to the inner circumferential surface of the projection 24 on the inside in the radial direction so as to cover the sleeve 10 by plasticity-deforming the projection 24 to the inside. A recess 41 is formed in the center portion of the plate 40. The disc-shaped washer 50 is disposed on the recess 41. The mounting plate 60 is fixed to the outer circumferential surface of the projection 25 on the outside in the radial direction by plasticity-deforming the projection 25 to the outside. The circuit board 70 is fixed on the mounting plate 60.

A rotary member 300 will now be described.

The rotary member 300 includes a shaft 80, a rotor holder 90, and a rotor magnet 100 which will be described later.

The shaft 80 obtained by processing a stainless steel plate in an almost cylindrical shape is inserted in the sleeve 10 and comes into contact with the washer 50. The shaft 80 is rotatably supported by the sleeve 10 and the washer 50. On the shaft 80, the rotor holder 90 as a rotary member obtained by performing plasticity-process such as press on a steel plate or the like into an almost cylindrical shape is fixed by press-fitting or adhesion. Alternately, the shaft 80 and the rotor holder 90 may be formed integrally.

In the portion fixed to the shaft 80, of the rotor holder 90, an inner cylindrical part 91 extending upward in the axial direction is formed by burring process. The outer periphery in the radial direction of the rotor holder 90 extends downward in the axial direction, thereby forming an outer cylindrical part 92 that envelopes the stator 30. A cover 93 connecting the inner cylindrical part 91 and the outer cylindrical part 92 is formed. The ring-shaped rotor magnet 100 is fixed to the inner circumferential surface of the outer cylindrical part 92 by an adhesive. The inner circumferential surface of the rotor magnet 100 and the outer circumferential surface of the stator 30 face each other via a small gap in the radial direction. A hall device 71 for detecting the magnetic pole of the rotor magnet 100 is mounted on the circuit board 70. The cover 93 is inclined upward in the axial direction from a some midpoint to slightly the outside in the radical direction. A flat surface is formed on the outer peripheral side of the cover 93, which is slightly higher in the axial direction of the inner side of the cover 93. An annular shaped rubber 110 is fixed to the flat surface by an adhesive, thereby forming a mounting part 94.

A recording disk holding apparatus 120 which is fixed to the outer circumferential surface of the inner cylindrical part 91 of the rotor holder 90 by press-fitting and holds the recording disk 2 having a disc shape by chucking the recording disk 2 so as to come into contact with the cover 93 is disposed.

By passing current from an external power source (not shown) to the stator 30, a magnetic field is generated. By mutual action between the rotor magnet 100 and the magnetic field, the recording disk 2 rotates and the rotation speed is controlled by the hall device 71.

General Configuration of Recording Disk Holding Apparatus 120

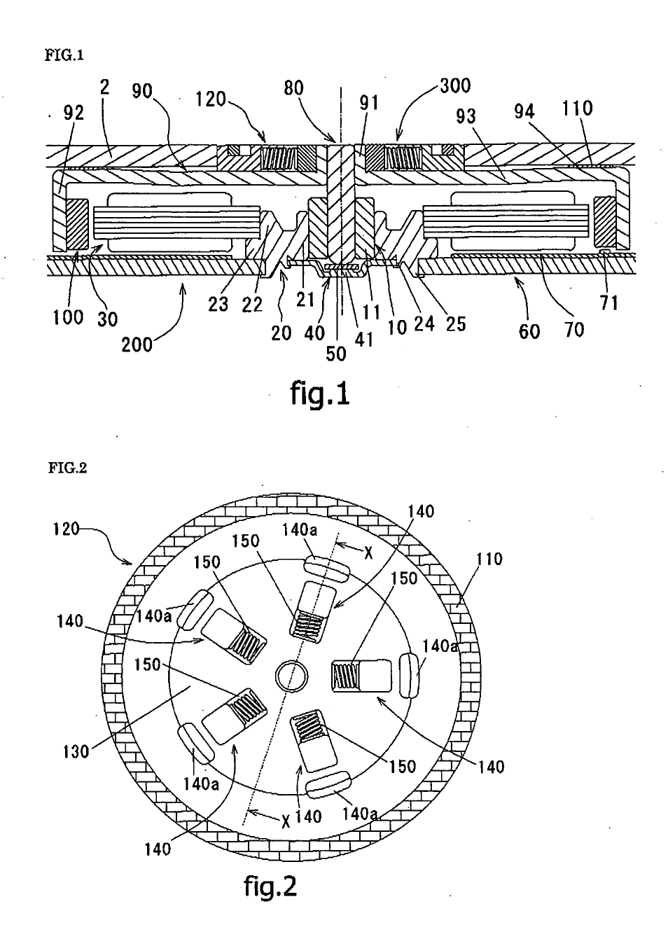

The main part of the recording disk holding apparatus 120 as a main part of the invention will now be described with reference to FIG. 2. FIG. 2 is a top view of a motor.

Referring to FIG. 2, in the recording disk holding apparatus 120, five disk holding shoes 140 are housed in equal intervals in the circumferential direction in a casing 130 having an almost cylindrical shape. The disk holding shoes 140 have nail portions 140a for holding a recording disk (not shown in FIG. 2) and elastic members 150 which are coil springs of the number corresponding to the number of the disk holding shoes 140, that is, five so as to be coupled between the center portion of the recording disk holding device 120 and the nail portions 140a in the radial direction. The rubber 110 as the mounting part on which a recording disk is to be mounted is disposed on the outer side in the radial direction of the casing 130.

Casing 130

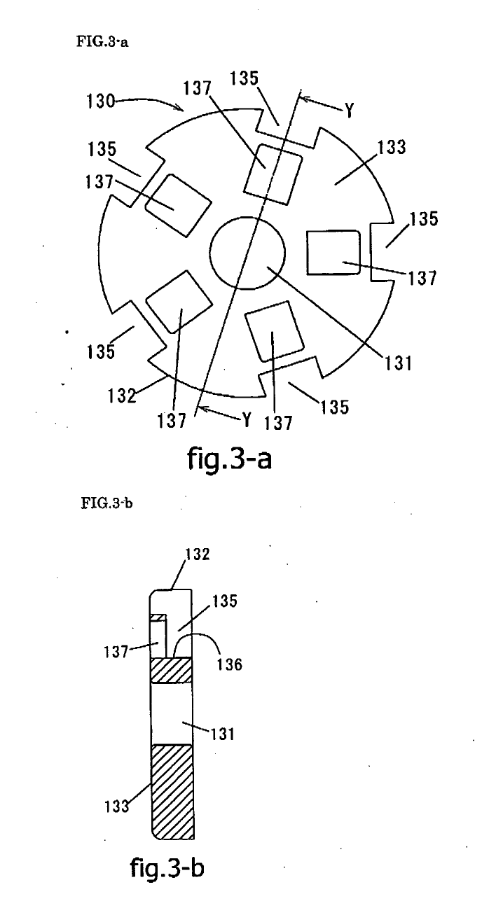

The structure of the casing 130 will now be described with reference to FIGS. 3A and 3B. FIG. 3A is a top view of the casing 130 and FIG. 3B is a cross section taken along line Y-Y of FIG. 3A. In FIG. 3B, the top side is regarded as the right side, and the bottom side is regarded as the left side.

With reference to FIG. 3A, the casing 130 is obtained by molding a resin material in an almost hollow cylindrical shape. The casing 130 has a hollow part 131 to be fixed to the outer peripheral surface of an inner cylindrical part 91 of the rotor holder 90, a cylindrical part 132 forming the outer peripheral surface as a side face of the casing 130, and a cover 133 connecting the hollow part 131 and the cylindrical part 132. Five radial spaces 135 for housing the disk holding shoes 140 are formed at intervals in the circumferential direction so as to extend from the cylindrical part 132 toward the hollow part 131. Referring to FIG. 3B, the height in the axial direction of the radial space 135 is about the half of the height in the axial direction of the casing 130. The length in the radial direction of the radial space 135 is about ⅔ of the radius of the casing 130. On the inside in the radial direction of the radial space 135, a contact face 136 which comes into contact with the elastic member 150 is formed. The contact face 136 is formed perpendicular to the direction of formation of the radial space 135. Five through holes 137 for holding the disk holding shoes 140 in the radial spaces 135 are provided in an intermediate portion in the radial direction of the cover 133 of the portion where the radial spaces 135 are formed (see FIG. 3A).

Nail Portion 140a

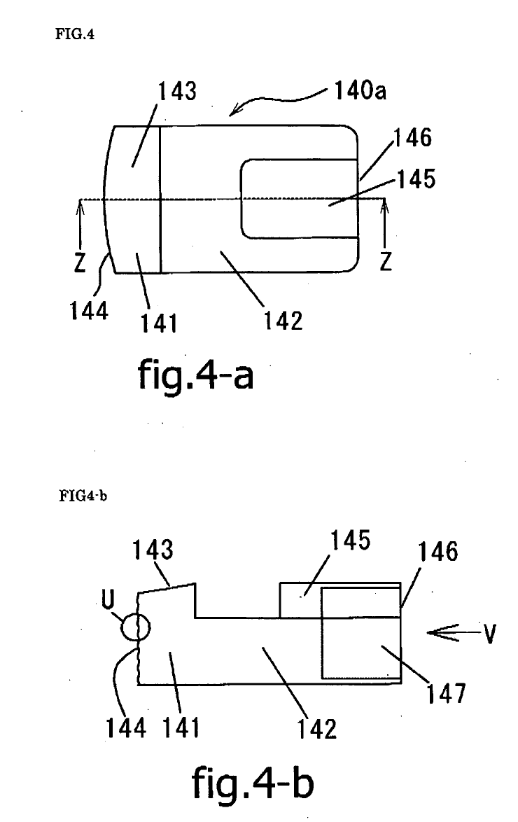

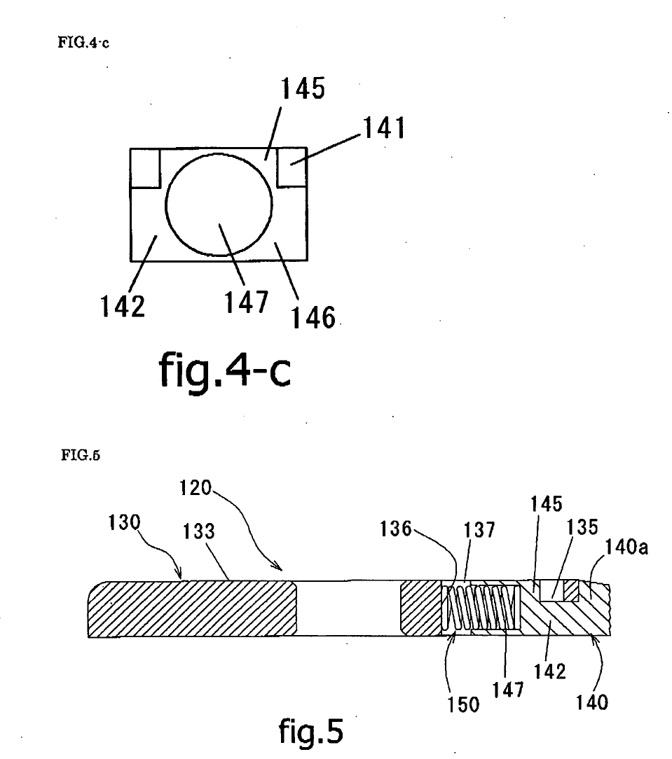

With reference to FIGS. 4A to 4C, the structure of the nail portion 140a will be described. FIG. 4A is a top view of the nail portion 140a, FIG. 4B is a cross section taken along line Z-Z of FIG. 4A, and FIG. 4C is a view seen from the direction of the arrow V in FIG. 4B. It is assumed that the outer side in the radial direction in FIGS. 4A to 4C is the side on which a contact face 144 is provided, and the inner side in the radial direction is the side on which a projection 145 is provided. The vertical directions in the specification coincides with those in FIG. 4B.

With reference to FIG. 4B, the nail portion 140a is made of a resin material. The nail portion 140a is formed by a nail portion 141 which comes into contact with the inner radius surface of the center opening having a circular shape provided in a recording disk (not shown in FIGS. 4A to 4C), and a base portion 142 housed in the casing 130. The nail portion 141 is constructed by a guide slope 143 which comes into contact with the lower edge of the inner radius surface of the center opening in the recording disk (not shown in FIGS. 4A to 4C) to support the core of the recording disk, and the contact face 144 which comes into contact with the inner radius surface of the center opening of the recording disk. The guide slope 143 is inclined downward in the axial direction to the peripheral end, that is, to the outer side in the radial direction. The curvature of the contact face 144 is desirably equal to that of the inner radius surface of the center opening in the recording disk. By making the curvatures equal to each other, the area of contact with the inner radius surface of the center opening of the recording disk, of the contact face 144 increases. Therefore, the pressure applied to the inner radius surface of the center opening of the recording disk can be reduced. As a result, deformation such as distortion of a recording disk can be suppressed.

The base portion 142 is formed in an almost rectangular parallelepiped shape extending to the inner side in the radial direction from almost the half on the lower side in the axial direction of the nail portion 141. On the opposite side in the radial direction to the nail portion 141 in the base portion 142, the projection 145 projecting upward in the axial direction is formed. The width in the circumferential direction of the projection 145 is smaller than that in the circumferential direction of the base portion 142 (see FIG. 4A). With reference to FIG. 4C, a housing recess 147 having a circular column shape housing the elastic member 150 is formed at an end face 146 on the opposite side in the radial direction of the contact face 144 between the projection 145 and the base portion 142. The width in the circumferential direction of the recess 147 is equal to or less than the width in the circumferential direction of the projection 145, and the depth in the radial direction of the housing recess 147 is equal to or less than the length in the radial direction of the projection 145.

Assembly of Recording Disk Holding Apparatus 120

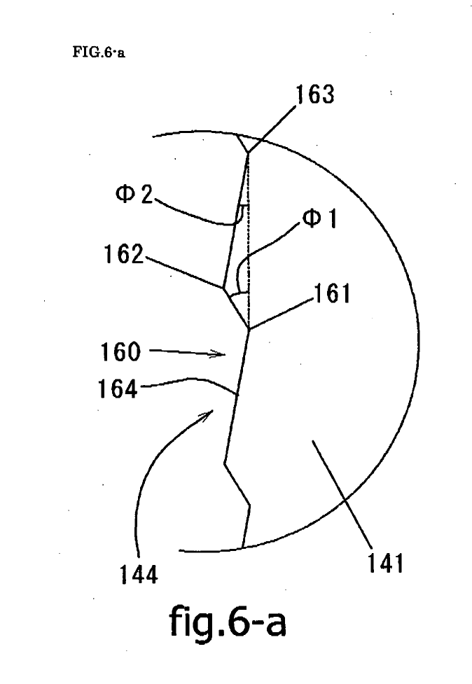

With reference to FIG. 5, assembly of the recording disk holding apparatus 120 will be described. FIG. 5 is a cross section taken along line X-X of FIG. 2. The vertical directions in the specification are the same as those (axial direction) of FIG. 5.

The elastic member 150 is partially housed in the recess 147 in the base portion 142 of the nail portion 140a. The housing recess 147 has desirably an outside diameter slightly larger than that of the elastic member 150 from the viewpoint of easiness of assembly. Since the elastic member 150 is housed, even when the nail portion 140a moves to the inside in the radial direction to shrink the elastic member 150, the force is not escaped in the axial direction but is used in the radial direction. Consequently, stable movement of the nail portion 140a can be realized.

The disk holding shoe 140 obtained by assembling the nail portion 140a and the elastic member 150 is housed in the casing 130. Since the radial spaces 135 as portions housing them in the casing 130 are formed in the lower end surface, the nail portion 140a and the elastic member 150 are housed in the radial spaces 135 from the lower end surface. The elastic member 150 comes into contact with the contact face 136.

The projection 145 of the nail portion 140a is housed in the through hole 137 in the casing 130. When housed, the height in the axial direction of the projection 145 and that of the cover 133 of the casing 130 are equal to each other. The width in the circumferential direction of the through hole 137 is equal to or slightly larger than the width in the circumferential direction of the projection 145. The length in the radial direction of the through hole 137 is larger than that of the projection 145. With the configuration, the projection 145 becomes movable in the radial direction. The upper end surface of the base portion 142 of the nail portion 140a comes into contact with the cover 133 in the hole 135 of the casing 130. Consequently, the disk holding shoe 140 is housed in the casing 130 with reliability.

Contact Face 144 of Nail Member 141

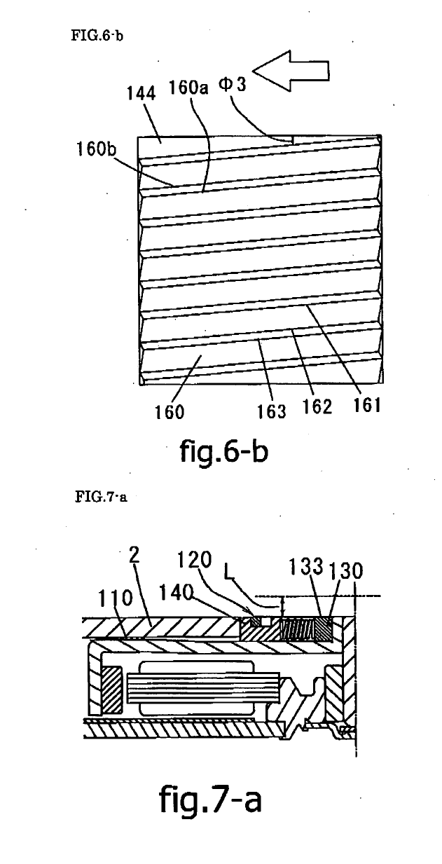

The contact face 144 of the nail portion 141 will be described with reference to FIGS. 6A and 6B. FIG. 6A is an enlarged view of a dot-line circle U in FIG. 4B as a cross section of the contact face 144. FIG. 6B is a front view of the contact face 144. In the specification, it is assumed that the outer side in the radial direction is the left side and the inner side is the right side.

In the surface of the contact face 144, a plurality of grooves 160 formed by mountains projecting to the outside in the radial direction and valleys recessed to the inside in the radial direction as shown in FIG. 6A are formed. The height from the bottom to the peak of the groove 160 is a few microns to hundreds microns. As shown in FIG. 6B, in the groove 160, a ridgeline 160a of the mountain and a ridgeline 160a of the valley are formed in the circumferential direction. Since the inner radius surface of the center opening of a recording disk (not shown in FIG. 6) is also not a perfect surface but has bumps and dips in micron unit, when the contact face 144 and the inner radius surface of the center opening of the recording disk come into contact with each other, the grooves 160 in the contact face 144 and the bumps and dips in the inner radius surface of the center opening of the recording disk engage with each other, thereby improving a frictional resistance force. With the configuration, occurrence of no engagement between the recording disk holding apparatus 120 and the recording disk can be prevented at the time of high speed rotation of the motor.

With respect to a triangle shape formed by bottom points of predetermined neighboring valleys of the grooves 160 in the contact face 144 and the apex of the mountain existing between the two bottom points, a first angle Φ1 as an angle of an acute angle portion formed by a straight line connecting a lower bottom point 161 as a bottom point of a lower valley and an apex 162 of a neighboring upper mountain and a dot line in the rotation axis direction (a) is formed so as to be larger than a second angle Φ2 as an angle of an acute angle portion formed by a straight line connecting the apex 162 of the mountain and an upper bottom point 163 as a bottom point of an upper neighboring valley. With the configuration, since the second angle Φ2 is smaller, an inclined surface 164 formed by the second angle Φ2 and the apex of the mountain plays the role of guiding a recording disk so that insertion can be smoothed. At the time of holding the recording disk, since the first angle Φ1 is larger, the mountains of the grooves 160 enter the recesses in the inner radius of the recording disk, and a force of holding the inner radius surface of the center opening of the recording disk can be applied largely. It is desirable to set the first angle Φ1 so as to be large as much as possible up to 80°. When the first angle Φ1 becomes larger than 80°, at the time of removing a recording disk, since the mountains of the grooves 160 are in the recesses in the inner radius surface of the center opening in the recording disk, the mountains of the grooves 160 are retained at the time of upward movement in the axial direction of the recording disk, the mountains may be cut. On the other hand, when the first angle Φ1 is small, the angle of contact between the surface of the groove 160 and the recording disk forming the first angle Φ1 becomes similarly small. The force of holding the recording disk becomes large in the radial direction, and the force applied in the axial direction decreases. Consequently, the effect of holding the recording disk in the axial direction decreases.

With reference to FIG. 6B, when the acute angle portion formed by the ridgeline 160a of the mountain or the ridgeline 160b of the valley and the horizontal line orthogonal to the axial direction is a third angle Φ3 in the circumferential direction, the third angle Φ3 is 30° or less. In particular, the inclination has to be downward in the axial direction with respect to the rotation direction (in FIG. 6B, the direction of the arrow is the rotation direction). When the disk holding apparatus rotates, the downward force in the axial direction works on the contact face 144, and the recording disk can be held with reliability. Even when a recording disk rises due to microvibration, impact, or the like, the recording disk can be held stably by the downward force in the axial direction. Therefore, a reliable brushless motor which is resistive to vibration and impact can be provided. Further, in a die for molding the nail portion 140a, by inclining the grooves 160 in the contact face 144 in the circumferential direction, a resin or the like as the material of the nail portion 140a is cast along the inclination. Therefore, the resin or the like enters to the narrow portion of the groove 160 and poor casting such as cut or cavity as a defect of the die can be prevented. At the time of detaching the die, the die can be detached while turning the die along the inclination, so that the die can be easily detached without damaging a molded piece.

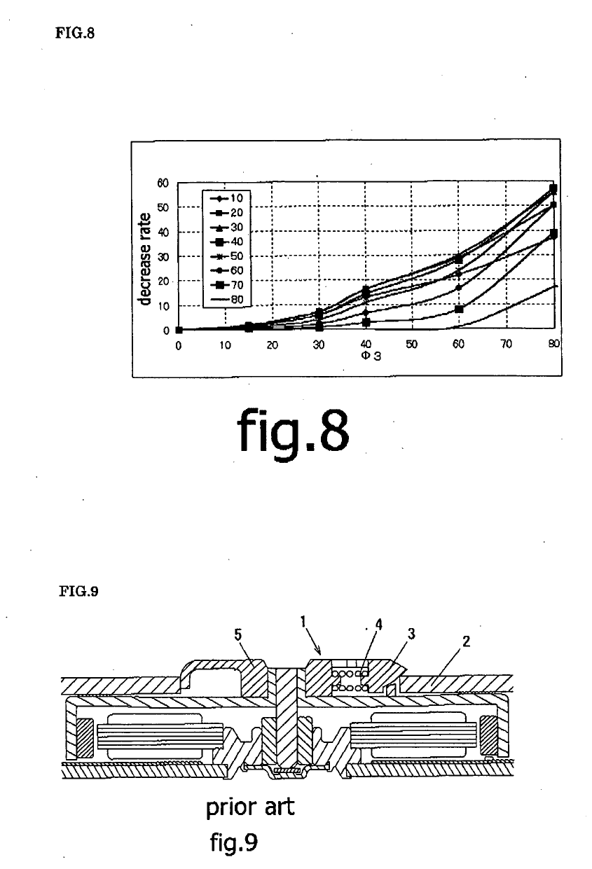

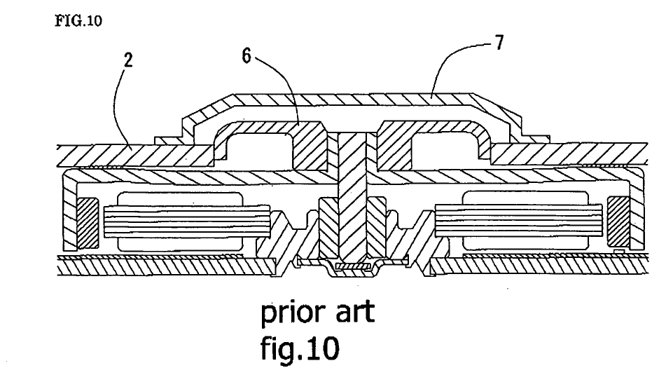

FIG. 8 is a graph showing the relation between a third angle Φ3 increased by 10° with respect to the first angle Φ1 and the holding force in the axial direction. The decrease rate of the holding force in the vertical axis from the case where there is no third angle Φ3, that is, the third angle Φ3 is 0° is shown.

It is understood from FIG. 8 that the larger the third angle Φ3 is, that is, the more the groove is inclined in the circumferential direction, the more the holding force in the axial direction decreases. Consequently, it is understood from FIG. 8 that the third angle Φ3 is desirably 30° or less because when the third angle Φ3 becomes 30° or larger, the rate of decrease of the holding force in the axial direction sharply increases. In the case where the third angle Φ3 is set to be larger than 30°, there is the possibility that a recording disk comes off due to microvibration in a stationary state, an external impact, or the like. In contrast, when the third angle Φ3 is set to 30° or less, the rate of decrease of the holding force in the axial direction is 10% or less, so that a recording disk does not come off due to microvibration in a stationary state, an external impact, or the like.

Positional Relation between Recording Disk 2 and Recording Disk Holding Apparatus 120

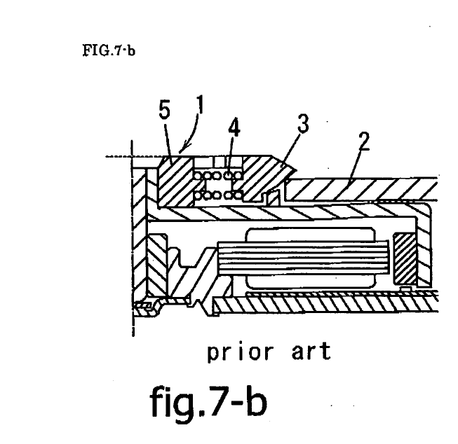

Finally, the position in the axial direction in the case where the recording disk 2 is held by the recording disk holding apparatus 120 will be described with reference to FIGS. 7A and 7B. FIGS. 7A and 7B are diagrams showing comparison between the structure and height of the embodiment of the present invention and those of the conventional technique. FIG. 7A is a schematic section of the embodiment of the invention and FIG. 7B is a schematic section of the conventional technique.

When the recording disk 2 is held by the recording disk holding apparatus 120, the under face of the recording disk 2 comes into contact with the rubber 110. At this time, the level in the axial direction of the cover 133 and the disk holding shoe 140 of the casing 130 of the recording disk holding apparatus 120 is equal to or less than the level of the top face of the recording disk 120. This can be realized by arrangement that the disk holding shoe 140 presses the inner radius face of the center opening of the recording disk 2 only in the radial direction. Conventionally, the top face side of the recording disk 2 is also pressed by a holding member, so that the casing 5 and the holding member 3 need a space L above them only by a portion pressed on the holding member 3. Therefore, the demand for thinning a brushless motor cannot be addressed. However, in the present invention, the cover 133 of the casing 130 and the disk holding shoe 140 are formed below the top face of the recording disk 2, so that the invention can address the demand for reduction in thickness. Thus, reduction in the thickness of a device on which the brushless motor is mounted can be realized.

Although the embodiment has been described above, the invention is not limited to the embodiment but can be variously modified.

For example, although the number of the disk holding shoes 140 of the embodiment is five, the invention is not limited to the number. It is sufficient that a plurality of disk holding shoes are arranged at equal intervals in the circumferential direction.

In the embodiment, the shape of the groove 160 formed in the contact face 144 of the nail portion 141 is the V shape as shown in FIGS. 6A and 6B. However, the shape of the groove 160 is not limited to the V shape. The portion of the apex 162 of the mountain may be round.

Although the housing recess 147 of the base portion 142 of the nail portion 140a that houses part of the elastic member 150 has a circular column shape, the housing recess 147 is not limited to the shape but may be any shape as long as it can house part of the elastic member 150. For example, the housing recess 147 may have a square pole shape.

Although a coil spring is used as the elastic member 150 in the embodiment, the elastic member is not limited to a coil spring but any elastic member can be used as long as it can energize the force to the outside in the radial direction. For example, a ring-shaped elastic member having a projection which is housed in the housing recess 147 of the base portion 142 may be used.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A recording disk holding apparatus for detachably holding a disk-shaped recording disk having a circular center opening, the apparatus being rotatable around a rotation axis, comprising:
a casing with a substantially cylindrical outer periphery, being inserted into the center opening of the recording disk, having a plurality of radially extending spaces arranged in a circumferential direction;
a mounting part formed around the cylindrical outer periphery of the casing, on which the recording disk is mounted; and
a plurality of disk holding shoes accommodated in the radially extending spaces with a pushing part which push the shoes radially outwardly to make each tip of the shoe press outwardly the inner circumferential surface of the circular opening of the recording disk at least in a state where the recording disk is placed on the mounting part;
wherein height of at least one of the casing and the disk holding shoes measured along the rotation axis from the mounting part is equal to or less than height of the recording disk measured along the rotation axis from the mounting part when the disk is mounted on the mounting part.

2. A recording disk holding apparatus according to claim 1, wherein the disk holding shoe comprises;
a nail portion which is a tip of the disk holding shoe and is projecting from the cylindrical outer periphery of the casing;
a base portion which is accommodated in the radially extending space in a state where the recording disk is mounted on the mounting part; and
an elastic member accommodated in the radially extending space and placed at radial inner end of the base portion pushing the base portion outwardly at least in a state where the recording disk is placed on the mounting part.

3. A recording disk holding apparatus according claim 2, wherein curvature of the cylindrical outer periphery of the casing measured in the circumferential direction is substantially the same to that of the nail portion measured in the circumferential direction.

4. A recording disk holding apparatus according to claim 2, wherein
the nail portion has an upper face which faces away from the mounting part; and
a guide slope is formed on the upper face at radially outer end portion thereof, which slants off from the radially inner portion of the upper face toward the mounting part.

5. A recording disk holding apparatus according to claim 2, wherein the base portion of the disk holding shoe has a recess for accommodating and holding part of the elastic member.

6. A recording disk holding apparatus according to claim 1, wherein
the disk holding shoe has a contact face at the radially outer end thereof; and
a plurality of grooves extending in a direction which slants off from the circumferential direction are formed on the contact face.

7. A recording disk holding apparatus according to claim 2, wherein
the disk holding shoe has a contact face at the radially outer end thereof; and
a plurality of grooves extending in a direction which slants off from the circumferential direction are formed on the contact face.

8. A recording disk holding apparatus according to claim 6, wherein, on a sectional profile of the grooves defined on a plane including the rotational axis and the tip of the disk holding shoe thereon, letting Φ2 be an acute angle between the rotation axis and lower side of an upper groove, Φ1 be an acute angle between the rotation axis and the upper side of an lower groove which is positioned axially next to the upper groove and closer to the mounting part, then the recording disk holding apparatus satisfies Φ1>Φ2.

9. A recording disk holding apparatus according to claim 7, wherein, on a sectional profile of the grooves defined on a plane including the rotation axis and the tip of the disk holding shoe thereon, letting Φ2 be an acute angle between the rotation axis and lower side of an upper groove, Φ1 be an acute angle between the rotation axis and the upper side of an lower groove which is positioned axially next to the upper groove and closer to the mounting part, then the recording disk holding apparatus satisfies Φ1>Φ2.

10. A recording disk holding apparatus according to claim 9, wherein Φ1 is equal or less than 80 degree.

11. A recording disk holding apparatus according to claim 6, wherein
the recording disk apparatus has a predetermined rotational direction; and
the distance between each groove and the mounting part is increasing with the groove extending toward the rotational direction.

12. A recording disk holding apparatus according to claim 11, wherein letting Φ3 be an acute angle between the direction in which the groove extends and a line perpendicular to the rotation axis, then Φ3 is equal to or smaller than 30 degree.

13. A motor comprising:
a rotary member rotatable around a rotation axis having a rotor magnet;
a fixed member having an armature magnetically coupled to the rotor magnet; and
a recording disk holding apparatus according to claim 1 fixed to the rotary member coaxially with the rotation axis.

14. A motor comprising:
a rotary member rotatable around a rotation axis having a rotor magnet;
a fixed member having an armature magnetically coupled to the rotor magnet; and
a recording disk holding apparatus according to claim 6 fixed to the rotary member coaxially with the rotation axis.

15. A recording disk holding apparatus for detachably holding a disk-shaped recording disk having a circular center opening, the apparatus being rotatable around a rotation axis, comprising:
a casing with a substantially cylindrical outer periphery, being inserted into the center opening of the recording disk, having a plurality of radially extending spaces arranged in a circumferential direction;
a mounting part formed around the cylindrical outer periphery of the casing, on which the recording disk is mounted;
a plurality of disk holding shoes accommodated in the radially extending spaces with an elastic part which push the shoes radially outwardly to make each tip of the shoe press outwardly the inner circumferential surface of the circular opening of the recording disk at least in a state where the recording disk is placed on the mounting part;
a nail portion which is a tip of the disk holding shoe and is projecting from the cylindrical outer periphery of the casing; and
a base portion which is a part of the disk holding shoe and is accommodated in the radially extending space in a state where the recording disk is mounted on the mounting part; wherein:
the recording disk apparatus has a predetermined rotational direction;
the disk holding shoe has a contact face at the radially outer end thereof;
a plurality of grooves extending in a direction which slants off from the circumferential direction are formed on the contact face; and
the distance between each groove and the mounting part is increasing with the groove extending toward the rotational direction.

16. A recording disk holding apparatus according to claim 15, wherein, on a sectional profile of the grooves defined on a plane including the rotation axis and the tip of the disk holding shoe thereon, letting Φ2 be an acute angle between the rotation axis and lower side of an upper groove, Φ1 be an acute angle between the rotation axis and the upper side of an lower groove which is positioned axially next to the upper groove and closer to the mounting part, then the recording disk holding apparatus satisfies Φ1>Φ2.

17. A motor comprising:
a rotary member rotatable around a rotation axis having a rotor magnet;
a fixed member having a stator magnetically coupled to the rotor magnet; and
a recording disk holding apparatus according to claim 15, fixed to the rotary member coaxially with the rotation axis.

18. A motor comprising:
a rotary member rotatable around a rotation axis having a rotor magnet;
a fixed member having a stator magnetically coupled to the rotor magnet; and
a recording disk holding apparatus according to claim 16, fixed to the rotary member coaxially with the rotation axis.
